(19) United States
(12) Patent Application Publication
(10) Pub. No.: US 2012/0305725 A1
(43) Pub. Date: Dec. 6, 2012

(54) LEASH ANCHOR AND BOARD INCORPORATING THE SAME

(76) Inventor: Kirk T. Dackow, Summit, NJ (US)

(21) Appl. No.: 13/584,216

(22) Filed: Aug. 13, 2012

Related U.S. Application Data
(63) Continuation-in-part of application No. 12/703,891, filed on Feb. 11, 2010.
(60) Provisional application No. 61/276,918, filed on Sep. 18, 2009.

(51) Int. Cl. F16G 11/03; B23P 17/04; A45F 4/00

(52) U.S. Cl. 248/231.81; 224/577; 29/428

(57) ABSTRACT

A recreational board comprises a first anchor for receiving a first portion of a support strap or leash having a free end for attachment to a user, and a second anchor spaced from the first anchor and adapted for attachment to a portion of the support strap or leash, to transform the support strap or leash into a transport or storage strap.

### CROSS-REFERENCE TO RELATED APPLICATIONS

This application is a continuation-in-part of U.S. application Ser. No. 12/703,891, filed Feb. 11, 2010, which claims the benefit of U.S. Application 61/276,918, filed Sep. 18, 2009, each of which is incorporated by reference herein in its entirety.

### FIELD OF THE INVENTION

The present invention relates generally to recreational boards such as body boards, skim boards, surf boards and snow boards that employ straps or leashes for attachment to a user's wrist or ankle, for example, and more particularly to a leash anchor provided on the board that transforms a support strap or leash into a storage or transport strap.

### BACKGROUND

Recreational boards such as body boards, skim boards and the like are typically used to ride waves at seaside locations and wave pools. Snow boards are used in a similar manner on ski slopes and other snowy or icy locations. These boards tend to be unwieldy and bulky, and as such are difficult to carry. Most users solve this problem by dragging the board behind them by the cord, or leash, that typically comes attached to the board, or by carrying the board under their arm. However, dragging the board risks damage to the board, and carrying the board limits what other items the user can carry. In addition, strong winds can cause a dragged board to fly around wildly, creating a danger to the user and others in the vicinity.

Various solutions have been presented that require the use or transport of separate carrying implements, such as are known for example in U.S. Pat. No. 4,804,025 to Bear, U.S. Pat. No. 5,083,692 to Treese, or U.S. Pat. No. 5,695,101 to Frietze. Such prior art solutions are often bulky or cumbersome and are impractical in a variety of situations, and especially during the transport of a board directly from the water to the user's towel, umbrella or the like. In addition, separate carrying solutions are susceptible to theft or misplacement and are often difficult or challenging to use.

There is a need, therefore, to provide a safe, convenient, and efficient way to transport a board without risk of injury to the user or the user's surroundings and without the use of separate carrying implements. More preferably, there is a need to provide a transport solution that primarily utilizes the board leash as a transport mechanism and that does not rely on separate carrying implements or the like. Such need is met by the various solutions described herein.

### SUMMARY

There is provided a recreational board comprising a first anchor for receiving a first portion of a support strap or leash having a free end for attachment to a user, and a second anchor spaced from the first anchor and adapted for attachment to a portion of the support strap or leash to transform the support strap or leash into a transport or storage strap. In one embodiment, the second anchor converts a standard board leash into, for example, an over-the-shoulder strap that allows the user to carry the board like a knapsack, freeing up both hands for the user. In certain embodiments, the second anchor is an attachment to the board for securing a portion of the leash or support strap. In other embodiments, the second anchor is a notch or opening in the board that provides a securing location for a portion of the leash or support strap. In general, however, the second anchor provides a user with the ability to use the support strap or leash in a multi-functional fashion, first as a tether during use of the board, and then as a transport or storage strap during periods of non-use.

### BRIEF DESCRIPTION OF THE DRAWINGS

FIG. 1 is one embodiment of a board incorporating a leash anchor in accordance with aspects of the present invention.

FIG. 2 illustrates one embodiment of the board of FIG. 1 with the leash anchor in use.

FIGS. 3-11 illustrate multiple embodiments of anchor fasteners.

FIG. 12 is an alternative embodiment of a board incorporating one embodiment of a leash anchor.

FIG. 13 illustrates one embodiment of a leash anchor kit or assembly.

FIGS. 14 and 15 illustrate one embodiment of a leash anchor in use.

FIGS. 16-19 illustrate multiple embodiments of leash anchor kits or assemblies.

FIGS. 20A and 20B illustrate an alternative embodiment of a board incorporating one embodiment of a connection strap and bracket-shaped leash anchor.

FIGS. 21A and 21B illustrate an alternative embodiment of a board incorporating one embodiment of a bracket leash anchor.

FIG. 22 illustrates an alternative embodiment of a board incorporating one embodiment of a recessed leash anchor.

FIG. 23 illustrates an alternative embodiment of a board incorporating one embodiment of a recessed leash anchor.

FIGS. 24A and 24B illustrate an alternative embodiment of a board incorporating one embodiment of a recessed spring-biased hook anchor.

FIGS. 25A-25F illustrate alternative embodiments of a board incorporating various embodiments of a notch leash anchor.

FIGS. 26A-26B illustrate an alternative embodiment of a board incorporating a notch leash anchor and a spring-biased leash latch.

FIGS. 27A-27C illustrate an alternative embodiment of a board incorporating various embodiments of a leash anchor in the form of an opening.

FIGS. 28A-28C illustrate an alternative embodiment of a board incorporating various embodiments of a leash anchor in the form of a board extension.

FIGS. 29A and 29B illustrate an alternative embodiment of an anchor fastener in the form of a resilient clip.

FIGS. 30 through 33 illustrate an alternative embodiment of an anchoring solution in the form of a leash clip that attaches to a board leash and that snaps onto an anchor attached to a board.

### DETAILED DESCRIPTION OF THE PREFERRED EMBODIMENTS

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

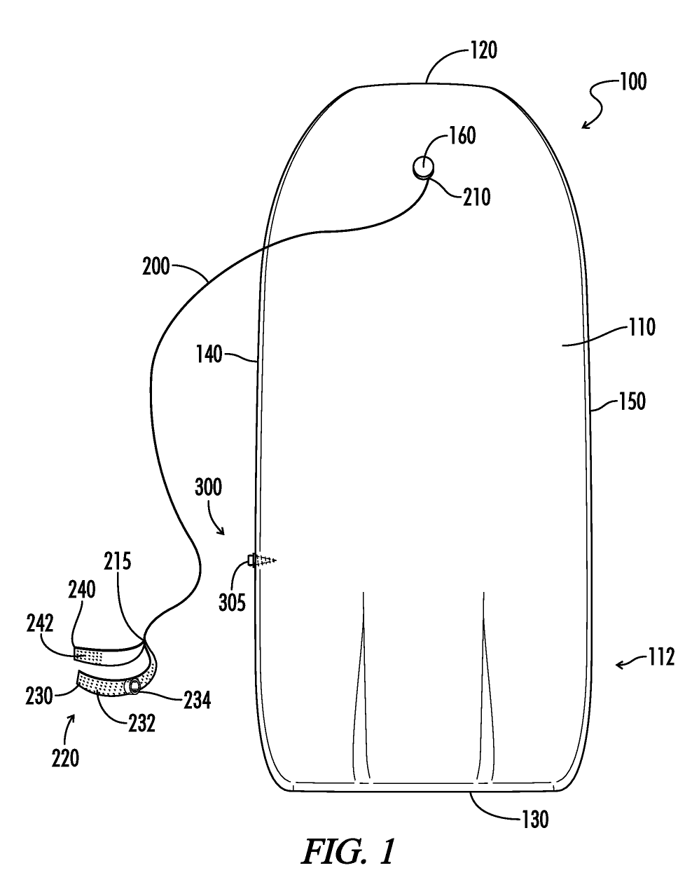

FIG. 1 illustrates one embodiment of a recreational board 100 of the type typically referred to as a body board or a boogie board. For purposes of explanation, use of the term “board” herein will generally refer to a variety of recreational boards, such as surf boards, body boards, snow boards, and the like. However, it will be understood by one skilled in the art that the scope of the term “board” should not be limited to any particular type, structure or configuration of board as shown or described herein, but that such term could also apply to any object where it is desired to convert a strap attached to such object into a transport or storage strap. For purposes of convenience, a body board 100 will be described herein to demonstrate aspects of the various embodiments of the present invention.

Board 100 further comprises a top surface 110 that typically supports a user's body (not shown) during use, opposing upper and lower edges 120, 130, and opposing side edges 140, 150. The lower portion 112 of the top surface 110 adjacent the lower edge 130 is typically contoured for water applications to enhance the aesthetic of the board 100 and the fluid flow properties around the trailing edge 130 of the board 100. Near the upper edge 120 of the board 100 is a first anchor 160 positioned on the top surface 110 for receiving and anchoring a first portion 210 of a leash or support strap 200 (hereinafter referenced as support strap) that has a free end 220 for attachment to a user (not shown), and typically the ankle of a user. The first anchor 160 extends into or completely through the body of the board 100 and fixes the support strap 200 to the board 100 as is known in the art. In the embodiment shown in FIG. 1, the free end 220 of the support strap 200 further comprises a first half 230 and a second half 240 that are provided with mating hook and loop fastener strips 232, 242 respectively that allow the first and second halves 230, 240 to removably engage around a user's ankle, for example. During use, a user would attach the free end 220 of the support strap 200 to the user's wrist or ankle so that the board 100 remains tethered to the user and is prevented from becoming separated from the user during a wipeout or the like, as is known in the art.

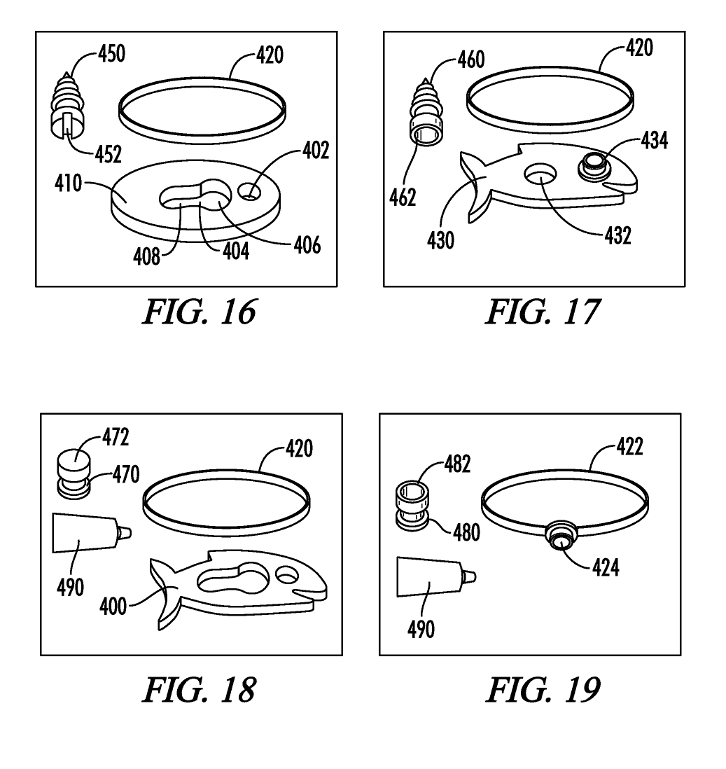

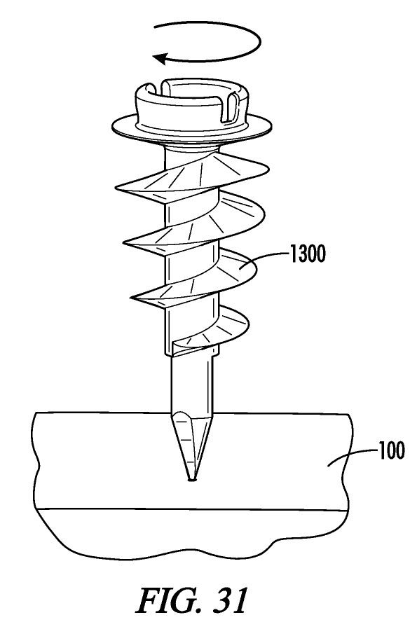

When it is desired to transport or store the board 100, a user can transform the support strap 200 into a transport or storage strap 225 by anchoring the support strap 200 to the board 100 at a second location spaced from the first anchor 160, to form a continuous loop formed by the board 100 and the strap 200, using a variety of solutions described herein. This enables the board 100 to be carried by a user as shown, for example, in FIG. 14, or hung by the support strap as shown, for example, in FIG. 28C. These solutions are not meant to be exhaustive, but are merely illustrative of various aspects of the inventive concept. Furthermore, because the support strap 200 is intended to function as a transport or storage strap, the anchor at the second location should be sufficient and robust enough to withstand separation under the weight of the board 100, i.e. during hanging storage, and in response to dynamic motion of user such as by walking or running.

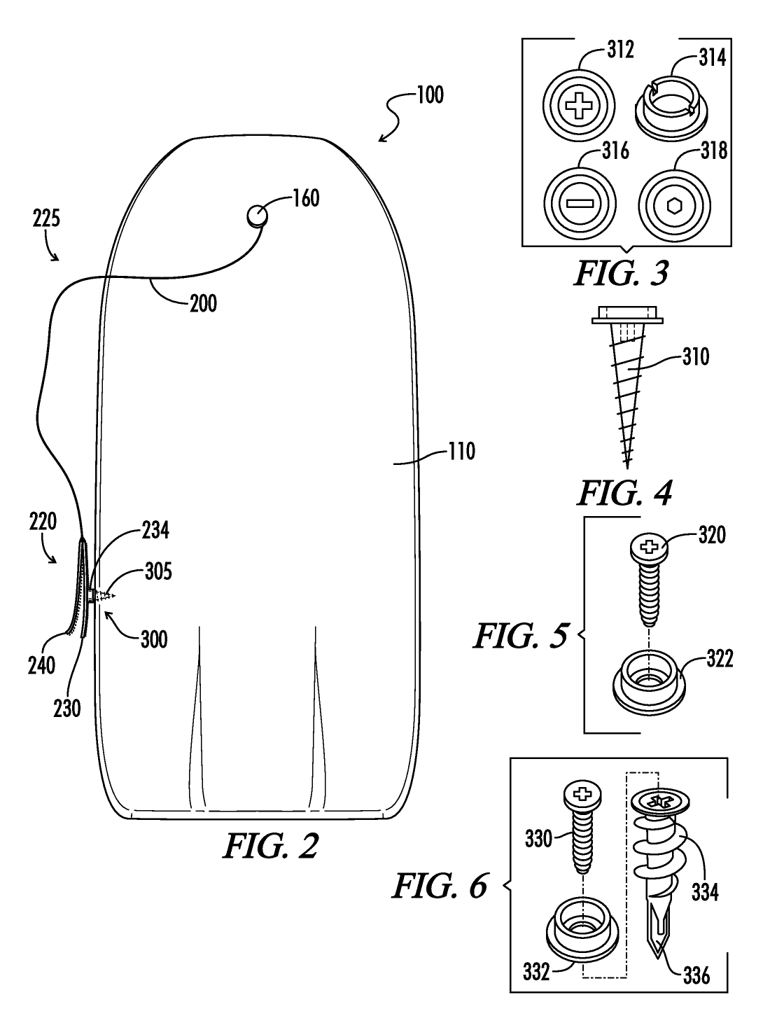

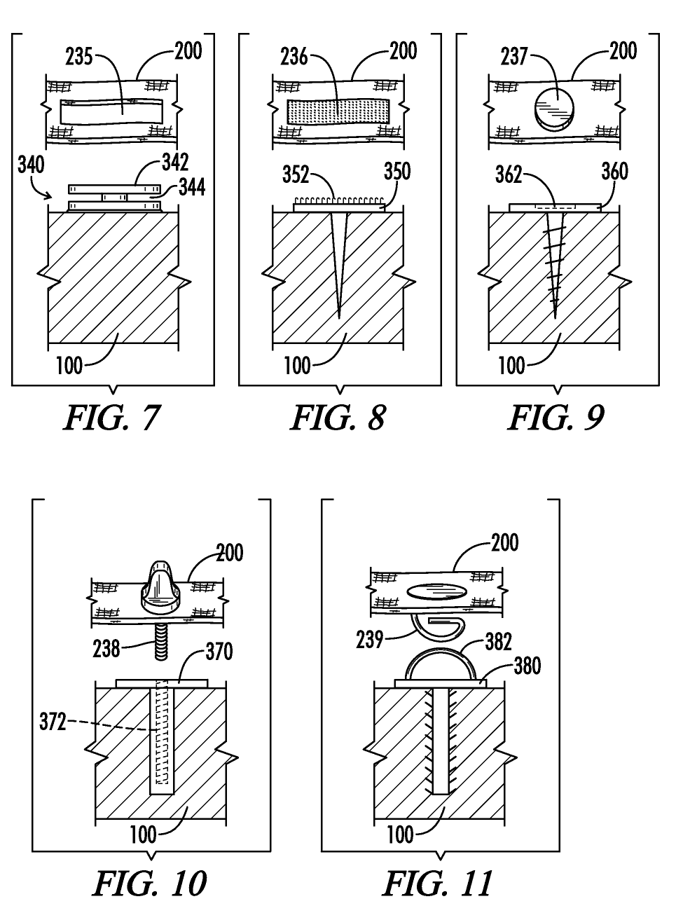

FIG. 1 illustrates one embodiment of a second anchor 300 including a low profile, male snap component 305 positioned on at least one of the edges of the board 100, and in FIG. 1 the side edge 140, for mating engagement with a female snap component 234 positioned on one of the halves 230, 240 of the free end 220 of the support strap 200, to transform the support strap into a transport or storage strap as shown in FIG. 2. In the embodiment of FIG. 1, the second anchor 300 penetrates into the body of the board 100 and can comprise a variety of different mating snap components including, but not limited to, a threaded fastener 310 (FIG. 4) having a variety of integrated snap heads 312 (Philips head), 314 (coin slot), 316 (flat screw) or 318 (hex screw) (FIG. 3) for mating engagement with the snap 234 on the support strap 200. Slotted head 314 is particularly convenient since it may be attached to the board 100 with a coin if the user does not have a screwdriver handy. Anchor 300 can also comprise a threaded fastener 320 including a separate snap head 322 (FIG. 5) that is secured directly into the board 100 (FIG. 2). Alternatively, a fastener 330 (FIG. 6) having a separate snap head 332 can be secured to a screw anchor 334 having a self-tapping tip 336 for easy installation. Other anchor solutions are possible. As shown in FIG. 2, a user would simply press the female snap component 234 on the support strap 200 into the male snap component 305 on the board 100, and then either hang the board 100 on a support hook (see FIG. 28C, for example) using the strap 200, or wear the strap 200 as a shoulder strap or the like (see FIG. 14 for example). Of course, the male and female aspects can be interchanged between the support strap and the board as desired.

The embodiments of FIGS. 1-6 require a user or board manufacturer to install the second anchor 300 into the body of the board 100. Since boards are typically lightweight and made from porous material, the installation of a penetrating second anchor 300 can be done with relative ease. Furthermore, the use of a threaded fastener prevents the anchor from unintentionally separating from the board. However, if it is desired not to impair the integrity of the board with a threaded fastener or the like, a non-penetrating second anchor can be applied with a marine-grade adhesive or the like, where the second anchor, such as a button component, is simply affixed to an outer surface of the board.

In addition, the second anchor 300 is preferably secured in a plane that is different from the plane of the first anchor 160, where the second anchor 300 is secured relative to an edge of the board 100, while the first anchor is secured relative to the top surface 110 of the board 100, such that the support strap is pulled in a different direction at the connection of the support strap with the first and second anchors 160, 300 respectively. This arrangement separates the force vector components at each of the first and second anchors 160, 300, so that the pulling forces at the first and second anchors are not aligned along the same plane or along the same axis. For example, if the second anchor was also positioned on or along the top surface 110 of the board 100, the pulling force along the first and second anchors would effectively be aligned, which would reduce the resistance to separation at the second anchor. Thus, for certain second anchor connections, it is preferable that the second anchor is not provided on the same surface as the first anchor. However, depending on the specific engagement of the support strap with second anchor, the location of the second anchor may not have an impact on the force components.

FIGS. 7-11 illustrate alternative mating engagements of a portion of the support strap with a board-based second anchor, where in each case the connection between the mating components should be of sufficient strength to enable the support strap to function as a storage or transport strap. FIG. 7 illustrates one embodiment of an adhesively applied button 340 having an outwardly extending face 342 and opening 344 for receiving a slot 235 formed in a portion of the free end 220 of the support strap 200, where the slot 235 is secured within the opening 344 and prevented from unwanted disengagement by the button face 342. In the embodiment of FIG. 7, the button 340 does not invade the body of the board 100 but is simply attached to an outer surface thereof. FIG. 8 illustrates one embodiment of a fastener 350 including a strip of hook and loop type material 352 that engages with a mating strip of hook and loop type material 236 provided on a portion of the support strap 200. FIG. 9 illustrates one embodiment of a fastener 360 including a magnetic surface 362 that engages with a magnetic material 237 of opposite polarity provided on a portion of the support strap 200. FIG. 10 illustrates one embodiment of a fastener 370 including a threaded bore 372 for receiving a hand screw component 238 secured through a portion of the support strap 200. FIG. 11 illustrates one embodiment of a fastener 380 including a loop 382 for receiving a hook component 239 secured through a portion of the support strap 200.

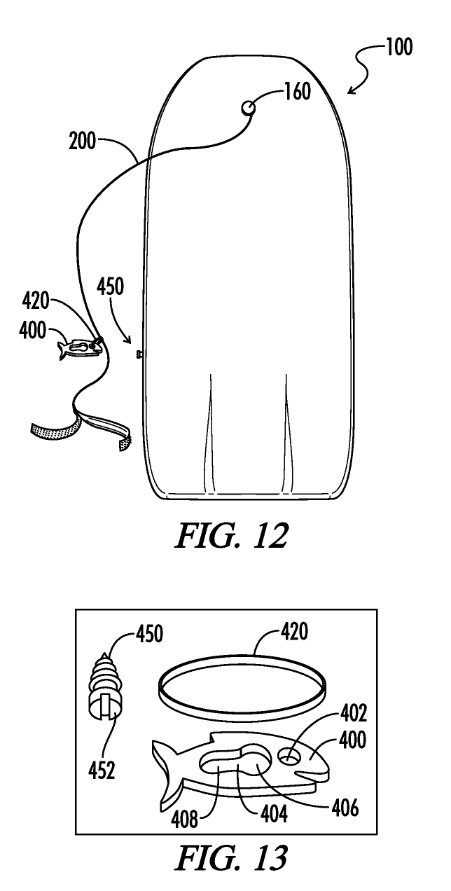

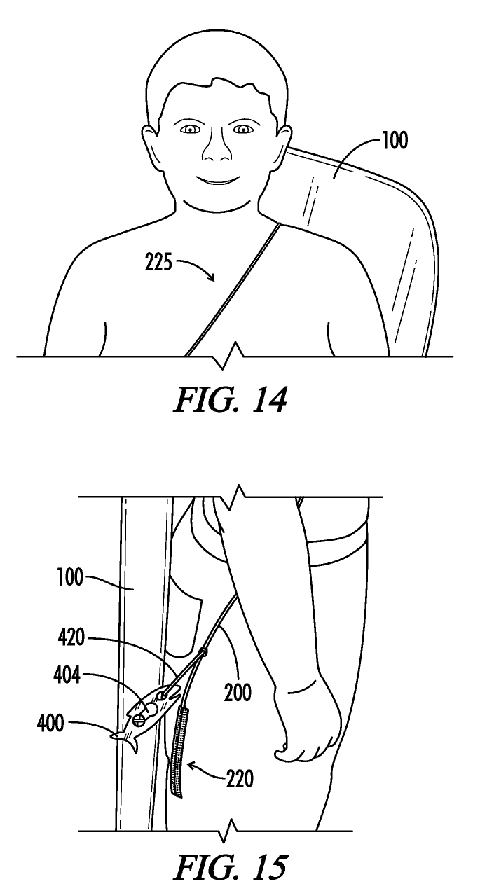

FIGS. 12-15 illustrate an alternative embodiment of an anchoring solution incorporating a connector 400 associated with the support strap 200 that couples the support strap 200 to a second anchor 450. The connector 400 is preferably a flexible plastic or rubber material or the like that is suited to withstand the elements and repeated use. In this embodiment, the anchoring solution is preferably in the form of an assembly or kit including a connector 400, a connector strap 420 preferably in the form of a flexible band for attaching the connector 400 to the support strap 200, and an anchor 450 for attachment to the board 100 and engagement with the connector 400. Of course, the anchor 450 can be pre-installed by the board manufacturer if desired. FIG. 13 illustrates one embodiment of a connector 400 having a first location 402 for accommodating the connector strap 420, and a second location 404 for receiving a head portion 452 of the anchor 450. In this embodiment, the second location 404 forms a keyhole-type combination opening, where the opening 404 includes a first diameter portion 406 that is used during engagement and disengagement of the connector 400 with the head portion 452, and a second diameter portion 408 that is used to secure the connector 400 with the head portion 452 as shown, for example, in FIGS. 14 and 15.

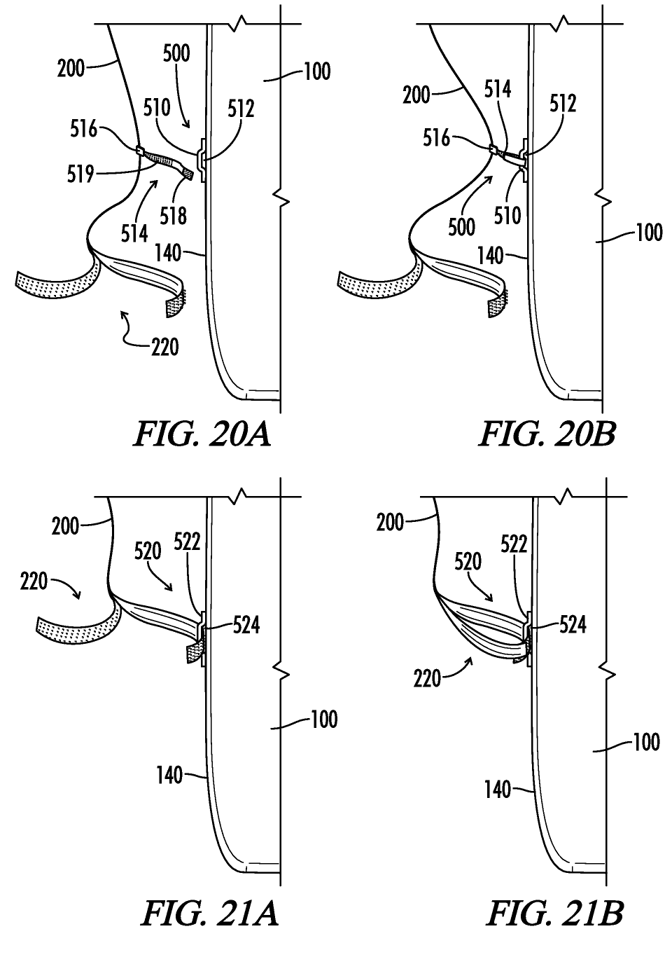

The connector 400 of FIGS. 12-15 is in the form of a fish to be consistent with aquatic theme of a body board or the like, although other fanciful or generic designs are possible. FIG. 16, for example, illustrates one embodiment of a connector 410 having a generic oval design, shown within an assembly of elements including a connector strap 420 and a similar threaded anchor 450 as shown in FIGS. 12-15. The connector 400 could also be designed to encase other items, such as a waterproof watch or an ID tag, or it could include a plastic Ziplock® type bag into the design that would provide the user with a small, water-resistant compartment for holding small items such as a key or money. Other functional features are possible. FIG. 17 illustrates an alternative embodiment of a connector 430 having a first location 432 for accommodating the connector strap 420, and a second location 434 for engagement with a head portion 462 of the anchor 460. In this embodiment, the first location 432 is an opening and the second location 434 is a snap component that is engageable with a mating snap component 462 on the anchor 460. FIG. 18 illustrates an alternative embodiment of an assembly or kit including a connector strap 420, a connector 400 similar to that shown in FIGS. 12-15, a non-penetrating anchor 470 having a connector-engaging head portion 472, and an attaching medium 490 such as, but not limited to, a glue or adhesive, for attaching the anchor 470 to a board 100 (not shown). FIG. 19 illustrates an alternative embodiment of an assembly or kit including a connector strap 422 having an integrated snap component 424, and a non-penetrating anchor 480 having a mating snap component 482 for engagement with the snap component 424 on the connector strap 422, and an attaching medium 490 for attaching the anchor 480 to a board 100 (not shown). The embodiment of FIG. 19 combines the functionality of the connector strap with the connector as shown, for example, in connection with FIGS. 12-18. The assemblies of FIGS. 13 and 16-19 could be vended separately from a board as a retrofit kit to an existing board, or any of the component elements could be vended separately as replacement parts if, for example, someone lost a connector strap, or a connector, or wishes to switch a fish-shaped connector with a human form connector, and so on.

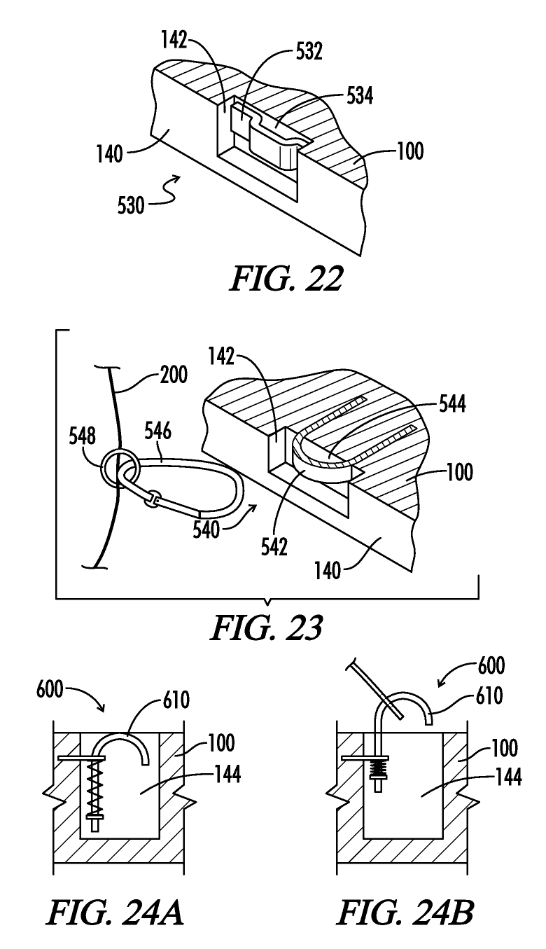

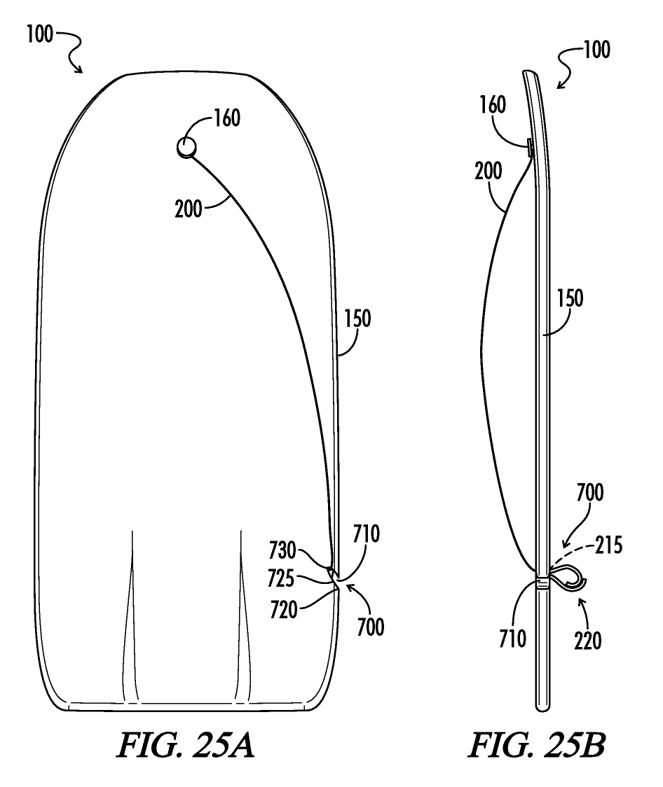

FIGS. 20A and 20B illustrate yet another embodiment of an anchor solution comprising a second anchor 500 in the form of substantially “U”-shaped bracket 510 attached to an edge 140 of the board 100 and that defines an opening 512 for receiving a portion of a connector strap 514 that is attached at one end 516 to the support strap 200. In the embodiment of FIGS. 20A and 20B, the free end 518 of the connector strap 514 includes a hook and loop portion that engages with a mating hook and loop portion on the body 519 of the connector strap 514. The end 516 of the connector strap 514 is preferably slidable along the support strap 200. FIGS. 21A and 21B illustrate another embodiment of an anchoring solution comprising a second anchor 520 in the form of substantially “U”-shaped bracket 522 attached to an edge 140 of the board 100 and that defines an opening 524 for receiving a portion of the free end 220 of the support strap 200. The embodiment of FIGS. 21A and 21B utilizes a minimum number of components and does not require the attachment of anything to the support strap 200 or free end 220; the strap itself serves as the connector.

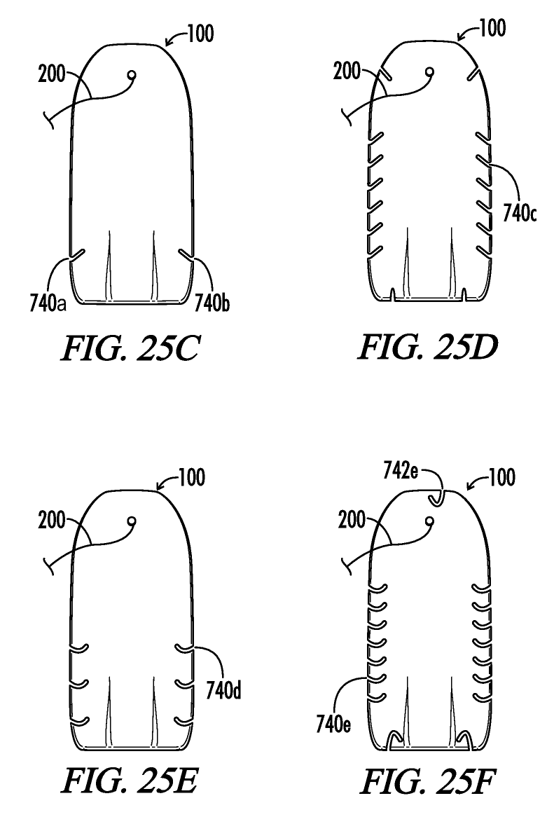

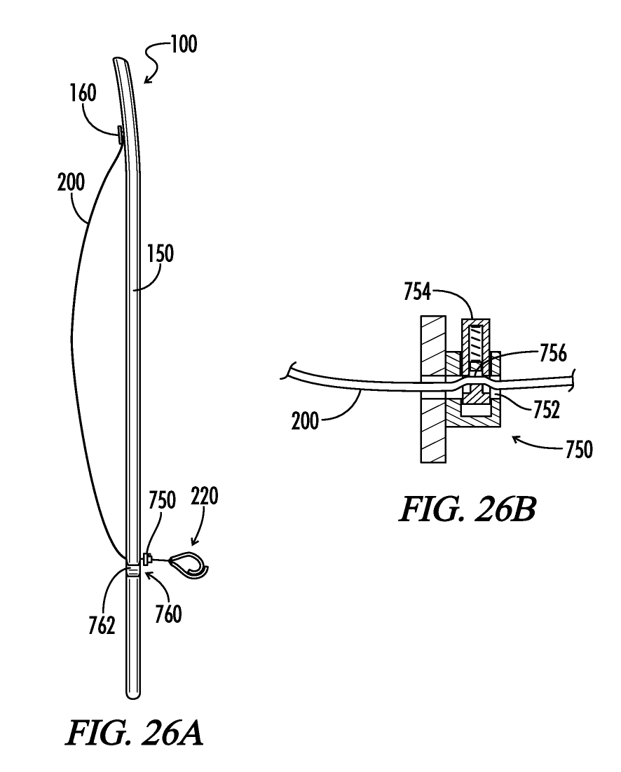

FIG. 22 illustrates an alternative embodiment of an anchoring solution comprising a second anchor 530 similar in the form of substantially “U”-shaped bracket 532 attached within a cavity 142 that is recessed into the board 100 relative to an edge 140 of the board 100 and that defines an opening 534 for receiving a portion of a connector strap, such as connector strap 514 as shown in FIGS. 20A and 20B, or for receiving a portion of the free end 220 of the support strap 200 as shown in FIGS. 21A and 21B. FIG. 23 illustrates an alternative embodiment of an anchoring solution comprising a second anchor 540 in the form of a board-penetrating staple 542 attached within a cavity 142 that is recessed into the board 100 relative to an edge 140 of the board 100 and that defines an opening 544 for receiving a portion of a connector strap, such as connector strap 514 as shown in FIGS. 20A and 20B, or for receiving a portion of the free end 220 of the support strap 200 as shown in FIGS. 21A and 21B, or for connection to a carabiner 546 attached to the support strap 200 by a joining ring 548 or the like. The anchors 530 and 540 of FIGS. 22 and 23 could also accommodate other means for connection to the support strap 200.

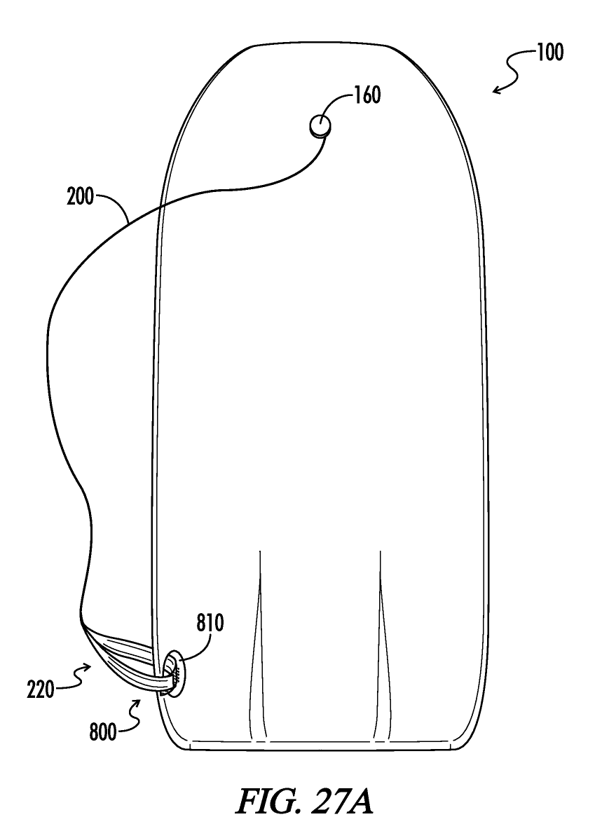

FIGS. 24A and 24B illustrate an alternative embodiment of an anchoring solution comprising a second anchor 600 in the form of a spring-biased hook 610 situated in a cavity 144 that is recessed into the board 100 relative to an edge of the board 100, such as edge 140. The hook 610 can be extended from the cavity 144 for easy access when a direct or indirect connection to the support strap is desired as described above, and it is recessed within the cavity 144 and out of the way during periods of non-use.

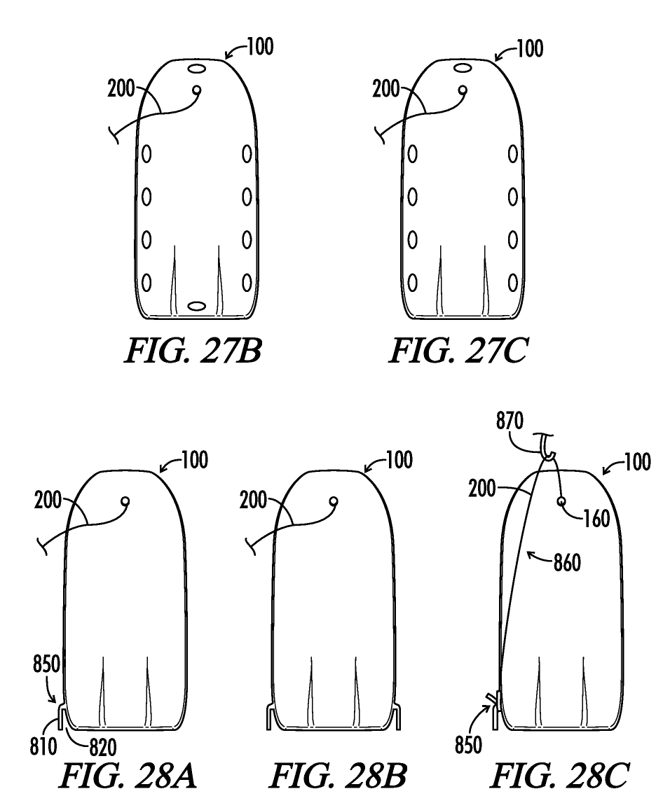

FIGS. 25A and 25B illustrate front and edge views of an alternative embodiment of an anchoring solution comprising a second anchor 700 in the form of an inwardly directed notch 710 that extends inward relative to an edge (here edge 150) of the board 100 a sufficient distance to capture the support strap 200 within the notch 710, and more particularly the junction 215 (FIG. 1) of the free end portion 220 with the rest of the support strap 200. Similar to the anchoring solution illustrated in the embodiment of FIGS. 21A and 21B, the anchor 700 of the embodiment of FIGS. 25A and 25B does not require a separate attachment on the support strap 200. The notch 710 generally starts at a location 720 along an edge of the board 100 and terminates at a location 730 spaced from the edge of the board 100, where the contour of the notch length 725 is suited to retain a portion of the support strap 200 during transport or storage conditions. FIG. 25C illustrates an alternative embodiment of a board having a pair of linear notches 740a and 740b along opposite edges of the board 100, while the embodiment of FIG. 25D illustrates a plurality of notches 740c along various edges of the board including the lower edge 130. While the notches shown in FIGS. 25A-25D are generally linear, the notches can be other than linear as shown, for example, in FIGS. 25E and 25F, which illustrate curved notch configurations 740d and 740e, where notch 742e shown in FIG. 25F for example might be used for hanging to board on a storage hook where is it desired to maximize the length of support strap available above the first anchor. Of course, the shape of the notches can be variable and is not limited to the shape or shapes or locations shown in the drawings, but can be any shape, depth and configuration as long as the notch is suited to retain a portion of the support strap 200 during transport or storage conditions. The notches could also be arranged to form an aesthetically pleasing or relevant configuration, such as the appearance of gills shown in FIGS. 25D-25F for example. Other configurations are possible.

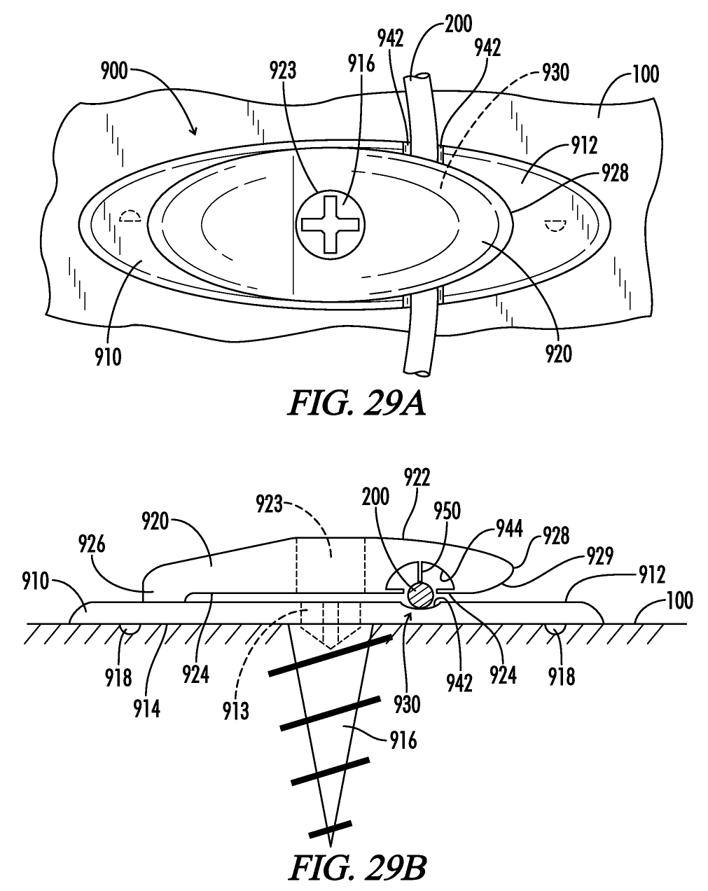

The embodiments of FIGS. 25A-25F result in a transport or storage strap that is generally defined by a fixed distance between the first and second anchors, where the support strap 200 is generally fixed by the engagement of the junction 215 (FIG. 1) of the free end with a notch. However, if it is desired to modify the connection of support strap with the notch, a slidable cord latch 750 could be attached to the support strap 200 before the free end 220, as shown in FIGS. 26A and 26B, to modify the distance between the first anchor 160 and where the support strap 200 is captured within the second anchor 760 or notch 762. The cord latch 750 functions similar to a drawstring bag closure and includes a passage 752 for the support strap 200 and a spring-biased a pin 754 having a channel 756 for passage of the support strap 200, the pin 754 being movable from a first position where the pin channel 756 is in alignment with the passage 752 for slidable movement of the cord latch 750 relative to the support strap 200, to a second position where the pin channel 756 is out of alignment with the passage 752 for securing the position of the cord latch 750 relative to the support strap 200. The pin 754 is biased into the second position at rest, which requires a user to press downwardly on the pin 754 to move the latch 750 relative to the support strap 200. The cord latch 750 of the embodiment of FIGS. 26A and 26B is preferably attached onto the support strap 200 before the support strap 200 is anchored to the first anchor 160.

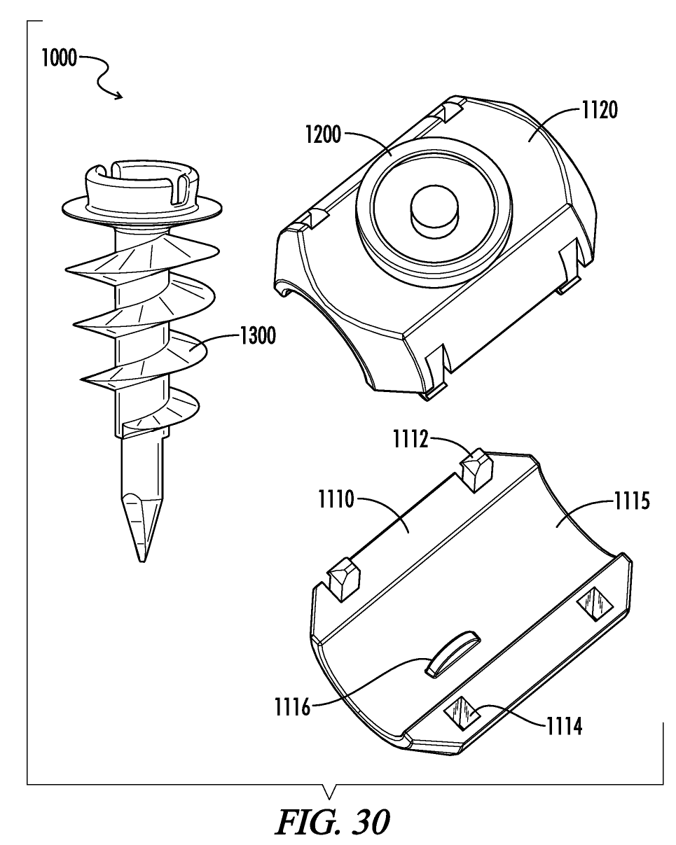

FIGS. 27A-27C illustrate an alternative anchoring solution where the second anchor 800 comprises an opening 810 formed in the board 100 at a location (see FIG. 27A), or a plurality of openings at a plurality of locations (FIGS. 27B-27C) that are spaced from an edge of the board for receiving the free end 220 of the support strap 200. This is similar to the anchor 520 of FIGS. 21A and 21B, where the free end alone 220 creates the connection between the support strap 200 and the second anchor 800. While FIGS. 27A-27C illustrate various opening configurations and locations, it will be appreciated that other locations and configurations are possible.

FIGS. 28A-28C illustrate an alternative anchoring solution where the second anchor 850 comprises an extension 810 formed in the board 100 at a location (see FIG. 28A), or a plurality of extensions at a plurality of locations (see FIGS. 27B), where the extension 810 forms a slot 820 for receiving the free end 220 (not shown) of the support strap 200. The extensions illustrated herein function similarly to the previously-described notch-based anchor solutions for generally capturing the free end 220 of the support strap 200, although the slot 820 is exterior to and extends outwardly relative to an outer surface of the board 100. FIG. 28C illustrates the creation of a storage strap 860 from the support strap 200 by fixing the connection of the support strap 200 at the first and second anchors 160, 850, and the retention of the storage strap 860 on a hook 870 for hanging the board 100 during periods of non-use.

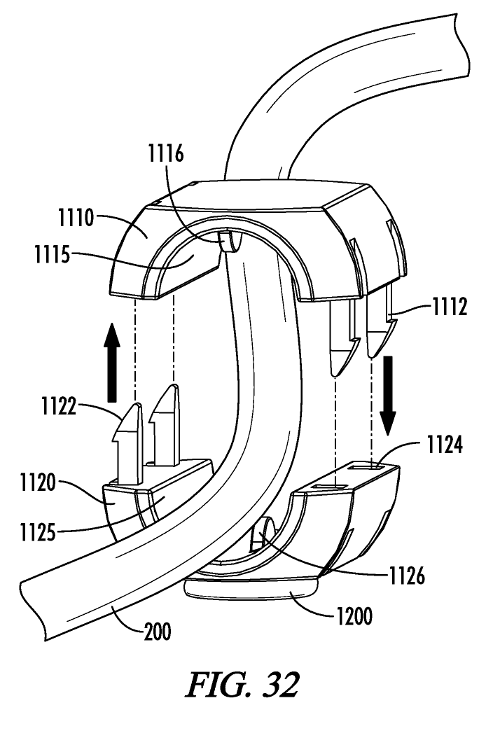

FIGS. 29A and 29B illustrate an alternative embodiment of an anchoring solution comprising a second anchor 900 that is attached to a surface of the board 100 and further comprises a base 910 having a top surface 912, a bottom surface 914 and an opening 913 formed therethrough for accommodating the passage of a fastener 916. At least one stabilizer 918, and preferably a plurality of stabilizers 918 on opposite sides of the opening 913 extend downwardly from the bottom surface 914 to bite into the board 100 and prevent the anchor 900 from rotating while the base 910 is being screwed into or unscrewed from the board 100. While a Philips head fastener 916 is illustrated, it will be appreciated that other fasteners may be used.

The anchor 900 further comprises a resilient clip 920 having an outer surface 922, an inner surface 924 adjacent the top surface 912 of the base 910, a first end 926 for attachment of the resilient clip 920 to the base 910, a free end 928 opposite the first end 926, and an access 923 defined between the outer and inner surfaces 922, 924 that is aligned with the opening 913 in the base 910. A guide 930 is defined between the base 910 and the resilient clip 920 for accommodating a portion of the support strap 200, the guide 930 further comprising a groove 942, 944 in at least one or both of the top surface 912 of the base 910 or the inner surface 924 of the resilient clip 920. One or more radial fingers 950 may extend into the guide 930 to increase the friction on the support strap 200 and help retain the support strap 200 within the guide 930. In use, a portion of the support strap would be forced against a cam surface 929 on the free end 928 of the clip 920, which would cause the clip 920 to deflect upward relative to the base 910 and allow a user to advance the support strap 200 into the guide 930 for retention in the grooves 942, 944 defined between the clip 920 and the base 910. The fingers 950 and the force of the clip 920 would deter movement of the strap 200 through the guide 930. When it is desired to remove the strap 200, a user simply has to lift the free end 928 of the clip 920 and pull the strap 200 away from the guide 930.

In the embodiments of FIGS. 29A and 29B, the clip 920 has a generic oval shape. However, other designs are possible. For example, the clip 920 could be adapted to accept a snap-on facing (not shown) that would allow users to customize the clip 920 with various designs. In addition, the clip itself 920 could be formed from a variety of designs without departing from the functionality as described herein. Such designs might include, but not be limited to, animals, flowers, monsters, corporate logos, team logos, country flags, and the like.

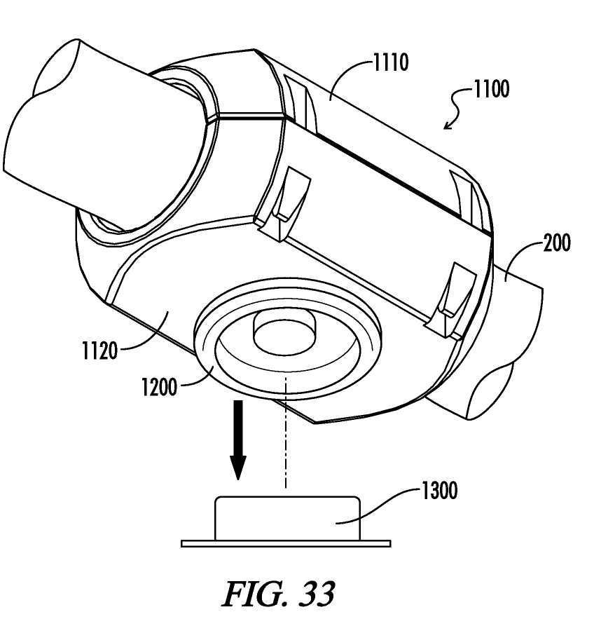

FIGS. 30 through 33 illustrate yet another embodiment of an anchoring solution 1000 comprising a board leash clip 1100 formed from a first half 1110 and a second half 1120, each half having at least one, and preferably a pair of prongs 1112, 1122 (FIG. 32) that engage with at least one, and preferably a pair of openings 1114, 1124 on the other half for mating the two halves 1110, 1120 together. The prongs 1112, 1122 are preferably spring-engaged with the openings 1114, 1124 for retaining the prongs 1112, 1122 within the openings 1114, 1124 for securing the first half 1110 to the second half 1120. Each half 1110, 1120 further comprises an additional protrusion 1116, 1126 (FIGS. 30, 32) extending outwardly from an inner surface 1115, 1125 on each half for engaging or biting into a board leash 200 for securing the position of the attached leash clip 1100. In the embodiment of FIGS. 30-33, one of the halves 1110, 1120 further comprises a snap 1200 for engaging an anchor 1300 (FIG. 31) that has been attached to or inserted into a board 100. The anchor 1300 is preferably threaded and self-tapping for easy insertion into the board 100. The two halves 1110, 1120 are initially placed around a leash 200 and then the two halves 1110, 1120 are snapped together (FIG. 32) through the engagement of the prongs 1112, 1122 with the openings 1114, 1124, wherein the engagement of the protrusions 1116, 1126 with the board leash 200 retain the leash clip 1100 in place (FIG. 33). Thereafter, the snap 1200 is engaged with the anchor 1300 (FIG. 33) to create a carrying strap out of the board leash 200 as shown herein. When it is desired to remove the leash clip 1100 from the board leash 200, one simply has to insert a pin or nail into the openings 1114, 1124 to release the engagement of the prongs 1112, 1122 with the openings 1114, 1124, and to thereby separate the halves 1110, 1120 from the board leash 200.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

I claim:

1. A leash clip for a board leash comprising:
a) a first half and a second half;
b) each half further comprising at least one prong that engages with at least one opening on the other half for attaching the first half to the second half around a board leash; and
c) an anchor engagement on at least one of the first or second halves for engagement of the leash clip with a board anchor for attaching the leash clip with an attached board leash to an anchor on a board, for attaching a board leash to a board and for transforming the board leash into a transport strap.

2. The leash clip of claim 1, wherein each half further comprises at least one protrusion for engagement with a board leash for biting into a board leash that is captured between an attached first and second half of the leash clip.

3. The leash clip of claim 2, wherein the mating engagement further comprises a pair of prongs and a pair of mating openings.

4. The leash clip of claim 3, wherein the prongs are spring engaged with the openings.

5. The leash clip of claim 4, wherein the anchor engagement is a snap.

6. A kit for transforming a board leash into a transport strap comprising:
a) an anchor for attachment to a board;
b) a leash clip for attachment to a board leash and comprising a first half and a second half;
c) a mating engagement comprising at least one prong on one half that engages with at least one opening on the other half for attaching the first half to the second half around a board leash; and
d) an anchor engagement on at least one of the first or second halves for engagement of the leash clip with the anchor for attaching the leash clip with attached board leash to the anchor on the board, for attaching the board leash to the board and for transforming the board leash into a transport strap.

7. The kit of claim 6, wherein each half further comprises at least one protrusion for engagement with a board leash for biting into a board leash that is captured between an attached first and second half of the leash clip.

8. The kit of claim 7, wherein the mating engagement further comprises a pair of prongs and a pair of mating openings.

9. The kit of claim 8, wherein the prongs are spring engaged with the openings.

10. The kit of claim 9, wherein the anchor is threaded and self-tapping for attachment to a board.

11. The kit of claim 10, wherein the anchor engagement is a snap.

12. The kit of claim 11, wherein the anchor further comprises a snap head for engagement with the snap anchor engagement on the leash clip.

13. A method for attaching a board leash to a board comprising:
a) inserting a self-tapping, threaded anchor into a board;
b) attaching a leash clip to a board leash, the leash clip further comprising a first half and a second half and a mating engagement comprising at least one prong on one half that engages with at least one opening on the other half for attaching the first half to the second half around the board leash, the leash clip further comprising an anchor engagement on at least one of the first or second halves for engagement of the leash clip with the anchor;
c) attaching the leash clip with attached board leash to the anchor on the board for transforming the board leash into a transport strap.

14. The method of claim 13, wherein each leash clip half further comprises at least one protrusion for engagement with the board leash for biting into the board leash that is captured between the leash clip halves.

15. The method of claim 14, wherein the mating engagement further comprises a pair of prongs and a pair of mating openings.

16. The method of claim 15, wherein the prongs are spring engaged with the openings.

17. The method of claim 16, wherein the anchor engagement is a snap.

18. The method of claim 17, further comprising snapping the leash clip onto the anchor.
